(19) United States
(12) Patent Application Publication
(10) Pub. No.: US 2026/0224430 A1
(43) Pub. Date: Aug. 6, 2026

(54) WEARABLE DEVICE FOR VISUAL ASSISTANCE, PARTICULARLY FOR BLIND AND/OR VISUALLY IMPAIRED PEOPLE

(71) Applicant: IVISION TECH S.P.A., Milano (IT)

(72) Inventor: Federico FULCHIR, Milano (IT)

(21) Appl. No.: 19/151,414

(22) PCT Filed: Jan. 30, 2024
(86) PCT No.: PCT/IB2024/050839

§ 371 Date: Jul. 28, 2025

(30) Foreign Application Priority Data
Jan. 30, 2023 (IT) 102023000001416

(51) Int. Cl. A61H 3/06

(52) U.S. Cl. CPC A61H 3/061; A61H 2003/063; A61H 2201/165; A61H 2201/5079; A61H 2201/5084; A61H 2201/5092; A61H 2205/022

(57) ABSTRACT

A wearable device for visual assistance includes
a position and/or movement sensor for detecting position and/or movement of the wearable device in the space and for generating a signal indicative of position and/or movement of the wearable device in the space;
distance sensors for detecting the distance objects in the space with respect to the distance sensor and to generate, a signal indicative of the distance of the objects from the distance sensor;
   acoustic generators for generating an acoustic signal and associated with the wearable device in two mutually distant positions. The device includes
   a processing unit for, at each instant of time:
   processing a warning signal associated with each of the objects having
   the position, velocity and acceleration of the object with respect to the wearable device and
   a risk index that identifies a risk attributed to the object; and
   actuating the acoustic generators to generate a plurality three-dimensional sounds.

### CROSS-REFERENCE TO RELATED APPLICATIONS

This application is a 35 U.S.C. § 371 National Stage patent application of PCT/IB2024/050839 filed 30 Jan. 2024, which claims the benefit of Italian patent application 102023000001416 filed 30 Jan. 2023, the disclosures of which are incorporated herein by reference in their entirety.

### TECHNICAL FIELD

The present disclosure concerns a wearable device for visual assistance, particularly for blind and/or visually impaired people. This wearable device is configured in particular as glasses designed to help blind and visually impaired people to perceive the environmental context and the moving objects surrounding them.

The device provides a self-learning module, which based on the user's behaviour in similar situations is able to anticipate and improve the accuracy of the scene analysis.

### BACKGROUND

Currently, a great need is felt to provide devices capable of assisting blind and visually impaired people in the perception, in real time, of the space that surrounds them and of the moving objects around them.

Today, there are devices capable of improving the vision of visually impaired individuals, which devices use image-processing technologies in order to provide the user with sharper images of what he or she sees, e.g. by compensating for peripheral vision problems, or by magnifying the images.

Such devices, however, can be used only by visually impaired people having nonetheless a residual visual capacity and are not suitable for blind people.

There are also hand-held devices capable of reading a written text being framed, or of recognising the face of a person, or an object, and of telling the user who or what it is.

These devices therefore perform specific functions of recognition of a text, a face or an object, and do not allow to perceive the surrounding environment, with all the variables that characterize it.

In any case, the currently existing devices for visual assistance are generally not wearable, and even if they are, they have bulky configurations and shapes, which do not go unnoticed and are uncomfortable to wear.

### SUMMARY

In light of the above, the task of the present disclosure is to realize a wearable device for visual assistance, particularly for blind and partially impaired people, which overcomes the limits of the prior art by allowing blind and partially impaired people to perceive, in real time and with greater ease, what surrounds them.

Within this task, aim of the present disclosure is to realize a wearable device for visual assistance that allows to immediately and effectively communicate to the user the presence of moving objects in the visual field of the same user, also signalling any criticalities and/or risks to which the same user must pay immediate or less immediate attention.

Another aim of the present disclosure is to realize a wearable device for visual assistance that is comfortable and lightweight to wear, and that is durable.

A further aim of the present disclosure is to realize a wearable device for visual assistance that is also aesthetically pleasing and elegant.

A further aim of the disclosure is realizing a wearable device for visual assistance that is capable of giving the widest guarantees of reliability and safety in use.

Yet another aim of the disclosure is realizing a wearable device for visual assistance that is easy to realize and economically competitive if compared to the prior art.

The above task, as well as the purposes mentioned and others that will better appear later, are achieved by a wearable device for visual assistance according to an independent claim and by a method of visual assistance, implemented by means of a wearable device, according to an independent claim.

Other features are provided in the dependent claims.

### BRIEF DESCRIPTION OF THE DRAWINGS

Further characteristics and advantages of the present disclosure will become more apparent from the exemplary but non-limiting description of a preferred embodiment of the present disclosure illustrated with the aid of the attached drawings in which:

FIG. 1 is a schematic representation of the wearable device for visual assistance according to the disclosure;

FIG. 2 is a first perspective view of a wearable device for visual assistance according to the disclosure;

FIG. 3 is a second perspective view of the wearable device of FIG. 2;

FIG. 4 is a top view of a wearable device for visual assistance, according to the disclosure, in which in particular the arrangement of some sensors and the relative measuring range are shown;

FIG. 5 is a side view of the wearable device of FIG. 4;

FIG. 6 illustrates a block diagram relative to the method of visual assistance implemented by means of the wearable device for visual assistance, according to the disclosure; and

FIG. 7 is a schematic representation of a variant of the wearable device for visual assistance according to the disclosure.

### DETAILED DESCRIPTION OF THE DRAWINGS

With particular reference to the figures, the wearable device for visual assistance, particularly for blind and/or visually impaired people, according to the disclosure, is indicated globally with the reference number 1, and comprises:
at least one position and/or movement sensor 3 configured to detect the position and/or movement of the wearable device 1 in the space and to generate a signal indicative of the position and/or movement of the wearable device 1 in the space;
a plurality of distance sensors 5 each configured to detect the distance d of one or more objects O1, O2 present in the space with respect to the distance sensor 5 itself and to generate, each one, a signal indicative of the distance d of such one or more objects O1, O2 from the distance sensor 5;
at least one pair of acoustic generators 7, 7′ each configured to generate an acoustic signal, wherein such acoustic generators 7, 7′ are associated with the wearable device 1 in two mutually distant positions;
a processing unit (9).

The processing unit 9 is configured for, at each instant of time:
receiving as input the signal indicative of the position and/or movement of the wearable device 1 and processing signals indicative of the position, velocity and acceleration of the wearable device 1;
receiving as input the signals indicative of the distance d of said one or more objects O1, O2 generated by the distance sensors 5 and processing signals indicative of the position, velocity and acceleration of said one or more objects O1, O2 with respect to the wearable device 1;
processing, on the basis of the signals indicative of the position, velocity and acceleration of the wearable device 1 and of the signals indicative of the position, velocity and acceleration of said one or more objects O1, O2 with respect to the wearable device 1, a warning signal associated with each of said one or more objects O1, O2;
actuating said pair of acoustic generators 7, 7′ to generate a plurality of three-dimensional sounds, each associated with a respective object O1, O2.

In particular, the warning signal processed by the processing unit 9 comprises, for each object O1, O2:
the position, velocity and acceleration of the object O1, O2 with respect to the wearable device 1 (and in particular relatively to the position, velocity and acceleration of wearable device 1 itself), and
a risk index that identifies the risk attributed to the object O1, O2, which may be a scaled, dimensionless numerical value.

Furthermore, the pair of acoustic generators 7, 7′ generates a plurality of three-dimensional sounds, each associated with a respective object O1, O2, wherein:
the tonality and/or pitch of the three-dimensional sound is associated with a respective object O1, O2;
the virtual point of origin of the three-dimensional sound is associated with the position of the respective object O1, O2 with respect to the wearable device 1;
the volume of the three-dimensional sound is associated with the risk index of the respective object O1, O2.

The term three-dimensional sound means a sound that is perceived by the wearer of the wearable device 1 as coming from a sound source located at a specific location in the three-dimensional space environment surrounding the wearer. This sound source can also be perceived as moving, with a certain velocity and acceleration, in such a three-dimensional spatial environment.

In this way, in essence, the wearable device 1 converts the scene of the environment surrounding the wearer, and in particular the objects and the obstacles around the same, either stationary or moving, large or small, into a polyphonic and multispatial sound stimulus, of immediate perception and interpretation by the wearer.

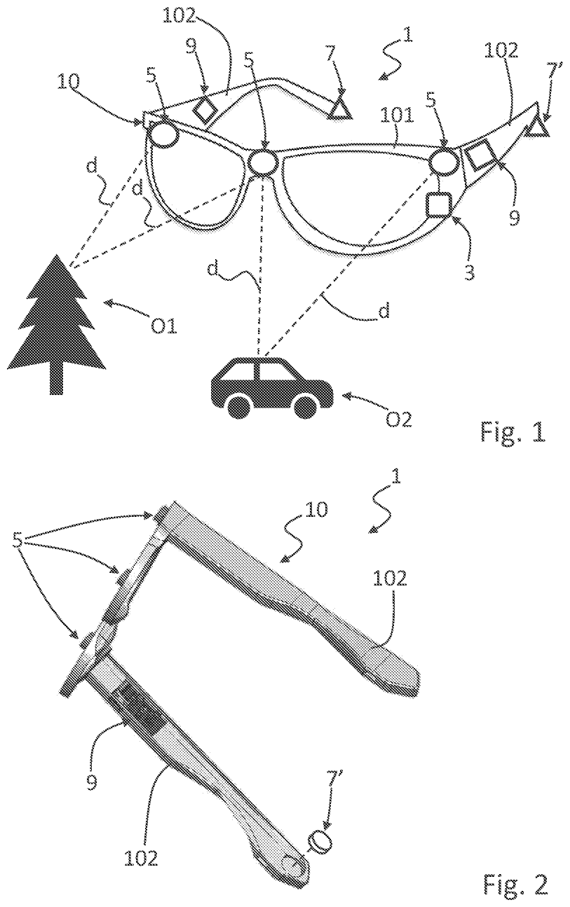

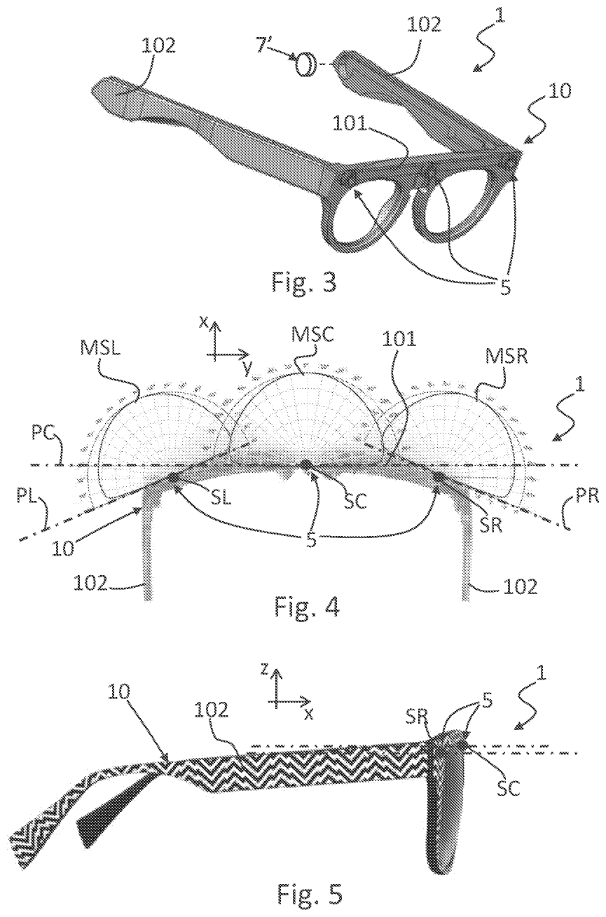

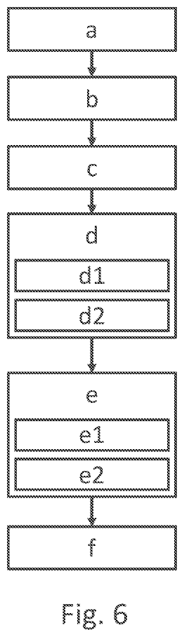

For example, with reference to FIG. 1, the wearable device 1 is able to generate for the object O1, i.e. a tree, a three-dimensional sound in C major tonality, placed in the three-dimensional auditory space at where the tree is positioned with respect to the wearable device 1, and with a low volume, proportional to the, low, risk index of the tree, and constant over time. At the same time for the object O2, i.e. a car that is approaching the wearer, the wearable device 1 generates a three-dimensional sound in G major tonality, which moves in the three-dimensional auditory space in a manner corresponding to the movement of the car in the physical space with respect to the wearable device 1, and with a high and increasing volume, proportional to the high and increasing risk index of the car.

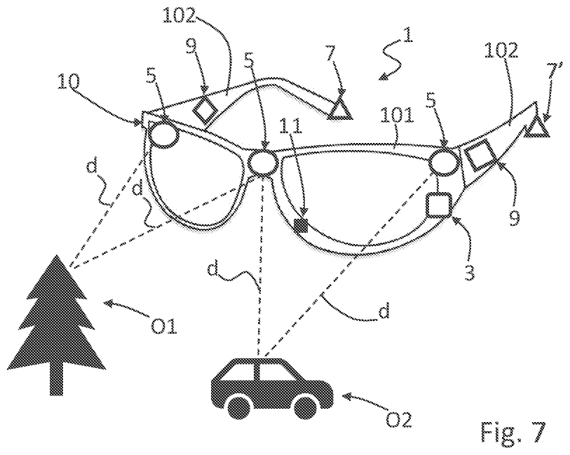

Preferably, as illustrated in particular in the variant of FIG. 7, the wearable device 1 comprises at least one acoustic sensor 11, such as for example a microphone, configured to detect environmental sounds and/or noises and to generate a corresponding environmental sound signal.

Preferably, the processing unit 9 is configured to receive in input this environmental sound signal and process a signal indicative of noises and/or sounds present in the surrounding environment. The warning signal is therefore processed also on the basis of the signal indicative of noises and/or sounds present in the environment.

In this way it is possible to process the scene acoustically, identifying general parameters (presence of crowd; traffic; isolation; strong wind or its absence; etc.). The “acoustic” scene at the time “T” will have an identification label that allows the device 1 to control the context more accurately (e.g. if there is a loud crowd or traffic noise, the sensor's analysis parameters can be lowered or sharpened to indicate only useful information to the user).

Advantageously, the wearable device 1 therefore allows to detect the density of objects present in the scene based on acoustic analysis, working by categories (implementable at the software memory level, e.g. with subsequent updates). The categories, by way of example, vary on the usual environmental situations (city traffic, packed crowd, pedestrian area, noise-free area). This makes it possible to set the sensitivity of the other analyses of the system based on dedicated configurations (e.g. in a heavy traffic environment, the analysis will necessarily concern only the closest and/or most dangerous objects, filtering out and omitting the many other pieces of information that would be superfluous): given an acoustic detection (e.g. every second), the current scene is assigned a category to which the scene analysis parameters correspond.

Preferably, the wearable device 1 is shaped like glasses 10 and therefore comprises a front 101 and a pair of temples 102.

The distance sensors 5 are preferably applied to the front 101, while the two acoustic generators 7, 7′ of the pair of acoustic generators 7, 7′ are respectively applied the one to one temple 102 and the other to the other temple 102 of the glasses 10, preferably near the ears of the wearer. Such positioning on the opposite sides of the wearer's head is particularly advantageous for the reproduction of a sound with the desired characteristics of three-dimensionality.

Preferably the distance sensors 5 are ultrasonic sensors.

Preferably, as illustrated in the accompanying figures, the distance sensors are three in number and are applied to the front 101 of the glasses 10 respectively at the two lateral ends and at the center of the front 101 itself.

In the embodiment illustrated in the accompanying figures, the ultrasonic sensors are indicated respectively with SL (left-side sensor), SC (central sensor), SR (right-side sensor).

As illustrated in FIG. 4, the three ultrasonic sensors SC, SR and SL each have a measuring range MSC, MSR, MSL having a very wide angle, in the order of 180°, so that almost the entire scene in front of the wearer of the wearable device 1 falls within the measuring range of at least two contiguous sensors.

Preferably, the three ultrasonic sensors SC, SR and SL lie on vertical reference planes, defined as PC, PR and PL, inclined with respect to each other. For example, the plane PL and the plane PR are inclined by a value comprised between 10° and 30°, for example equal to 23°, with respect to the PC plane.

Preferably, in fact, as illustrated in FIG. 4, the glasses 10 have, in the frontal plane, a “meniscus” shape, that is, the front 101 has a curvature with respect to the frontal plane. Therefore, the three distance sensors 5, applied to this “meniscus”-like front 101, lie on vertical reference planes inclined with respect to each other and with respect to the frontal plane of the glasses 10 themselves.

As illustrated in FIG. 5, moreover, it is possible to provide that also the horizontal reference planes on which the sensors SC, SR and SL lie are offset in the vertical direction, the horizontal plane on which the sensor SC lies being for example at a greater height than the horizontal plane on which the sensors SR and SL lie. The expression horizontal plane basically means the walking plane.

As an alternative to the ultrasonic sensors, the distance sensors 5 can be infrared sensors, such as for example sensors of the ToF type (from the acronym “Time of Flight”).

According to a further alternative, the distance sensors 5 can be LIDAR sensors, from the acronym “Laser Imaging Detection And Radar”.

Possibly the distance sensors 5 may also comprise a plurality and/or a combination of ultrasonic, infrared and LIDAR sensors.

Preferably, the acoustic generators 7, 7′ are bone conduction transducers, or earphones, capable of generating a sound that is transmitted to the wearer through the vibration of the bones. These bone conduction earphones advantageously allow the ears to be left free so as to allow the wearer to listen to the environmental sounds and noises.

The bone conduction earphones may be applied to the temples 102 of the glasses 10 so as to be positioned, in use, at the wearer's cheekbones, or at the temporal bone, or still at a position behind the earlobe.

Alternatively, or in addition, the pair of acoustic generators 7, 7′ may comprise a pair of airborne loudspeakers, also in this case preferably positioned outside the ear canal so as to allow the wearer to listen to the environmental sounds and noises, and placed on the sides of the head.

The wearable device 1 may also comprise at least one electromechanical or electromyographic actuator 9 adapted to be placed in contact with the skin of the wearer and configured to generate a mechanical or electrical stimulation on the basis of the properties of the warning signal generated by the processing unit 9.

Advantageously, the skin behind the earlobe is quite sensitive and lends itself to being stimulated by an electromechanical actuator or by an electromyographic actuator.

The electromechanical actuator may comprise a matrix of stimulating elements, for example a 4×4 matrix, capable of generating a sensation adapted to reproduce a two-dimensional map of approximate representation of the warning signals generated by the processing unit 9. The stimuli can, for example, be perceived as a point pressure on the skin, exerted at various intensities in relation to the risk index and at different points of the stimulation matrix. The electromechanical actuator may in fact comprise a matrix of 4x4-pins moved by nano-electromagnets.

A similar sensation of point pressure according to a two-dimensional map given by a 4×4 matrix can also be recreated by means of an electromyographic actuator, that is, thanks to an electrical rather than mechanical stimulation of the user's skin.

Preferably the at least one position and/or movement sensor 3 may comprise one or more of: an accelerometer, a magnetometer, a gyroscope, or a GPS.

The wearable device 1 advantageously comprises a rechargeable battery for powering all the electrical and electronic components.

The processing unit 9 may further comprise a wireless connection module, such as for example a Bluetooth connection module, for connection with smarthpone and other electronic devices.

Furthermore, the wearable device 1 may comprise, for example on the temples 102, an input device, such as for example a touch-type portion, adapted to allow interaction with the wearer.

In the case of a glasses-like configuration of the wearable device 1, the material used to make the glasses 10 may be acetate, this material being suitable for integration with the electronic and sensor components.

The disclosure also concerns a method of visual assistance, implemented by means of a wearable device for visual assistance 1 as described above, comprising the following steps:
a. detecting the position and/or movement of the wearable device 1 in the space by means of at least one position and/or movement sensor 3 and generating a signal indicative of the position and/or movement of the wearable device 1 in the space;
b. detecting, by means of a plurality of distance sensors 5, the distances d of one or more objects O1, O2 present in the space with respect to the distance sensor 5 itself and generating a signal indicative of the distance d of said one or more objects O1, O2 from such a distance sensor 5;
c. processing, on the basis of the signal indicative of the position and/or movement of the wearable device 1, signals indicative of the position, velocity and acceleration of the wearable device 1;
d. processing, on the basis of the signals indicative of the distance d of said one or more objects O1, O2 generated by the distance sensors 5, signals indicative of the position, velocity and acceleration of said one or more objects O1, O2 with respect to the wearable device 1;
e. processing, on the basis of the signals indicative of the position, velocity and acceleration of the wearable device 1 and of the signals indicative of the position, velocity and acceleration of said one or more objects O1, O2 with respect to the wearable device 1, a warning signal associated with each of said one or more objects O1, O2, wherein this warning signal comprises:
   i. the position, velocity and acceleration of said object O1, O2 with respect to the wearable device 1, and
   ii. a risk index that identifies the risk attributed to said object O1, O2, which may be a scaled, dimensionless numerical value;
f. generating a plurality of three-dimensional sounds, each associated with a respective object O1, O2, wherein:
   i. the tonality and/or pitch of each three-dimensional sound is associated with the respective object O1, O2;
   ii. the virtual point of origin of each three-dimensional sound is associated with the position of the respective object O1, O2 with respect to the wearable device 1;
iii. the volume of each three-dimensional sound is associated with the risk index of the respective object O1, O2.

Preferably, step c. allows, starting from the signal indicative of the position and/or movement of the wearable device 1 detected by the position and/or movement sensor 3, to obtain position (X, Y, Z), velocity V(X, Y, Z) and acceleration A(X, Y, Z) of the wearable device at the time T, i.e. to obtain POS(T)=((X, Y, Z), V(X, Y, Z), A(X, Y, Z)). The position in the space (X, Y, Z) of the wearable device 1, expressed for example in metres, is defined with respect to an initial position (0,0,0) of the device 1 itself.

Preferably the distance sensors 5 are ultrasonic sensors adapted to generate a signal comprising:
i. a first signal indicative of the radial distance d of an object O1, O2 from the sensor itself, and
ii. a second signal indicative of the amplitude of the ultrasound reflected from said object O1, O2.

Preferably step d. comprises the following steps:
d1. comparing, for each distance sensor 5, the respective second signals indicative of the amplitude to establish whether said second signals are to be attributed to the same object O1, O2 among the objects present in the scene;
d2. if such second signals are attributed to the same object O1, O2, triangulating the first signals indicative of the radial distance d of said same object O1, O2 to obtain the signals indicative of the position and velocity of said same object O1, O2 with respect to the wearable device 1.

In particular, each ultrasonic distance sensor 5 generates radial distance signals, in millimetres, of the objects O1, O2 that are detected and, for each object detected, a-dimensional, amplitude signals, as well which within certain minimum deviations are characteristic of the object O1, O2 itself and therefore identifying the same based on physical form and signal absorbency characteristics (for example ultrasound in the case of ultrasonic sensors) typical of the material(s) of composition of the object O1, O2.

Objects O1, O2 placed at the same distance from a distance sensor 5 could be in any position (in particular “to the right or to the left” with respect to the distance sensor) on the sphere with center in the distance sensor 5 itself. In fact, two or more samplings are indistinguishable if they are at the same distance, except for their amplitude.

An object O1, O2 sampled by the three sensors SC, SL, SR is considered approximately the same object if it has an amplitude that varies by +/−5% between one sensor and the other. The samplings performed by the three sensors SC, SL, SR for the same object O1, O2 allow to obtain its instantaneous position in the space with respect to the wearable device 1, and therefore also to obtain the velocity and acceleration of the same.

Considering for example only the dimensions X, Y in a horizontal plane, and leaving out the information relative to the vertical plane Z, the sampling of the sensors SC, SL, SR at the time T can be indicated with SAMPL(T) and it returns the position of the objects O1, O2 detected by comparing the values of the vectors of the signals (of radial distance and amplitude) of the three sensors SC, SL, SR at the time T.

In particular, by indicating with “sampling(sensor)” the list of the signals sampled by a given sensor, SAMPL(T) can be calculated as follows:
the sampling(SL), sampling(SC), and sampling(SR) are ordered on the basis of the amplitude signal;
With the following cycle, the values are compared:
   I consider one by one the sampling(SC) amplitudes=(a₁ ... aₙ)_{SC}; these amplitudes are indicated with (aᵢ)_{SC};
   With logarithmic search it is searched for the amplitude closest to (aᵢ)_{SC} in sampling (SL)=(aⱼ)_{SL}: if (aᵢ)_{SC} differs from (aⱼ)_{SL} by +/−5% it is considered that the sampling is relative to the same object O1, O2;
   With logarithmic search it is searched for the closest amplitude in sampling(SR)=(aₖ)_{SR}: if (aᵢ)_{SC} differs from (aₖ)_{SR} by +/−5% it is considered that the sampling is relative to the same object O1, O2;
   If there is no match, the sampling is deleted as not relevant, otherwise the distances x, y in the horizontal plane are calculated by triangulation and the triad R=(A, Dx, Dy)=(amplitude, distance x in mm, distance y in mm) is added in SAMPL(T)
   It is thus obtained at the time T, SAMPL(T)={R₁ ... Rₙ}.

In the case of the presence of an acoustic sensor 11, the parameters (number of samples, number of objects detected, etc.) are to be considered dependent on the type of scene indicated by the acoustic analysis of the moment “T”.

Since the sampling (SC) amplitudes (but also the sampling (SL) amplitudes and the sampling (SR) amplitudes) can have similar values for similar but distinct objects, the sampling is ordered firstly on the basis of the amplitude signal and then also on the basis of the distance signal. Therefore, elements with equivalent amplitude are compared as follows: if (d₁)_{SL}, (d₂)_{SL}, (d₁)_{SC}, (d₂)_{SC}, (d₁)_{SR} and (d₂)_{SR} are the distances of equivalent objects detected by the 3 sensors, the amplitude values are ordered based on the distance from each sensor. It is then assumed that the closest objects (relatively to the various sensors) are nonetheless the same objects. In other words, the list of the objects with corresponding amplitude values is ordered and the values of the object closest to the single sensor are matched in the same order to the same object. In this way, in the event that two distinct objects “generate” for the three sensors, comparable amplitude values, the information relative to the distances of the two objects detected by the three sensors makes it possible to discriminate the samplings to be attributed to one object from those to be attributed to another object.

Preferably step e. comprises the following steps:
e1. comparing, for each object O1, O2 referred to in step d2, the signals indicative of the amplitude, at the current instant of time and at the previous instant of time, to establish whether such signals indicative of the amplitude are to be attributed to the same object O1, O2;
e2. attributing the warning signal only to said objects O1, O2 identified in step el.

In other words, also taking into account the fact that the position of the wearable device 1 can change from one instant of time to the other, it is appropriate to verify that, in two successive instants of time, a certain sampling carried out by the sensors SC, SR, SL is relative to the same object O1, O2, in order to be able to monitor the evolution of its movement.

Preferably, the risk index identifying the risk attributed to an object O1, O2 is established on the basis, at least, of the difference between the velocity and acceleration signals of the object O1, O2 itself with respect to the wearable device 1 at the current instant of time and the velocity and acceleration signals of the object O1, O2 with respect to the wearable device 1 at the previous instant of time.

In this way, the risk index takes into account the fact that, between an instant of time and the previous one, a certain object O1, O2, is approaching, with a certain velocity and with a certain acceleration, the wearer.

The method of visual assistance described above therefore essentially provides for a step of identification of the objects O1, O2 present in the measuring range of the wearable device 1, in terms of position, velocity and acceleration and risk.

At each instant of time T, the distance sensors 5 perceive inputs that are translated, with appropriate transforms, into scene objects O1, O2 (e.g., obstacles), which in the following discussion will be defined as BLOBs.

Below is a description of a practical example of definition, in real time, of the set B of the BLOBs of a scene:

At the time Y, T, with cycles of for example 200 milliseconds:
1. POS(T) is detected
2. SAMPL(T) is detected
3.a If set B is empty, the BLOBS {B₁ . . . Bₙ} are added as follows:

For each Rᵢ=(A, Dx, Dy)ϵ SAMPL(T), the BLOB Bᵢ=(Rᵢ, POS(T), T, TA, H, W, S)=(A, Dx, Dy, (X, Y, Z), V(X, Y, Z), A(X, Y, Z), T, TA, H, W, S) is initialized where:
T is the detection time,
TA is the last update time (initially equal to T),
H=true, is a Boolean value (indicates whether or not Bi is visible at the instant T),
W=integer parameter (from 0 to 100) indicating the risk of the BLOB, set to 0 (0=low risky; 100 =risky),
S=parameter indicating “the tonality” of the BLOB (as described below).
3b. If set B is not empty, the following calculation is performed.

For each BLOB Bi its position is updated based on what is detected by POS(T):
(X, Y, Z) is updated considering the difference of the scalar and vector values in POS(T) and in Bi (i.e. new assumed distance)
Dx, Dy are updated accordingly,
TA is updated.
For each Rⱼ=(A, Dx, Dy)ϵ SAMPL(T) the amplitude value A of Rⱼ (indicated with A(Rⱼ)) is compared with the amplitude value A of Bᵢ (indicated with A(Bⱼ)),
The minimum value |A(Rⱼ)-A(Bⱼ)|is sought.

If this value |A(Rⱼ)-A(Bⱼ)|is below the 10% threshold, it is considered that the sampling Rⱼ is associated with the same object of Bi: in this case the values of Bᵢ are updated as follows:
W is calculated based on the difference in velocity and relative acceleration; if these are negative (i.e. they correspond to an approach towards the wearable device 1) the W value is increased as follows (also dependent on the parameters of the acoustic scene):
if the modulus of the distance is higher than 3 metres, DD=1 is set
if the modulus of the distance is higher than 2 metres, DD=5 is set
if the modulus of the distance is higher than 1 metre, DD=10 is set
if the modulus of the distance is higher than 0 metres, DD=50 is set

The increase of W is equal to: DD+velocity difference modulus+acceleration modulus square (calculation of the difference of the modulus POS(T) and the relative value of Bᵢ) normalized between 0 and 100.
H=true is set
the remaining values of Bi (A, Dx, Dy, (X, Y, Z), V(X, Y, Z), A(X, Y, Z), T) are updated accordingly.

If the value |A(Rⱼ)-A(Bⱼ)| is not below the 10% threshold, the value of H is set to false, and T is not updated.

If the BLOB B; has TA>100 cycles (i.e. for 100 cycles the T value of this BLOB Bi has not been updated), Bi is deleted from the BLOB list, freeing memory.

For the generation of three-dimensional sounds, only the current BLOBS having the parameter H=true are taken into account.

The BLOBS are processed by the processing unit 9 for the generation of the three-dimensional sounds taking into account the position, distance, velocity, acceleration and risk parameters.

The conversion of the BLOBs for the acoustic generators 7, 7′ mainly uses stereo-acoustic functions that make it possible to effectively make a sound transmittable with its parameters (point of origin, direction, direction and approach vectors) as if it were a sound present in the environment.

As regards the definition of the three-dimensional sounds to be emitted by means of the acoustic generators 7, 7′, it can follow the following rules.

First of all, an array of available tonalities, to be associated with the individual BLOBs is defined. In the event that a BLOB is present in the memory of the processing unit 9, a specific tonality (the first one available within the aforesaid array) is associated with it.

In the event that a BLOB is deleted from the memory, the tonality is freed.

If there are several BLOBs, each BLOB then “sounds” in its own specific tonality, which is maintained as long as this BLOB is in the memory.

The tonalities that are used can be, for example, in sequence, the following:
1. C major
2. G major
3. D major
4. F major
5. B Flat Major

In the case of more than five different BLOBs, the aforesaid tonalities can be chosen from time to time, at a higher octave and then at a lower octave, for a total of potential thirty BLOBs at the same time.

The tonalities are then cyclically assigned to different BLOBs as a function of their presence in the memory.

The volume of the sound associated with the BLOB in the memory is attributed in proportion to the risk (from 0 to 100).

In addition, on the tonality of the specific BLOB it is also possible to generate 3 possible “sounds” that transmit, together with the volume, the risk index of the BLOB.

For example, in the case of C major tonalities, the following can be emitted:
A steady note (e.g. central note C natural) when the risk is lower than 35 out of 100;
A third major (e.g. C natural-E natural) when the risk is lower than 60 out of 100;
A dominant seventh chord (e.g. C-E-B flat) when the risk is greater than or equal to 60 out of 100.

In practice, it has been found that the wearable device for visual assistance, according to the present disclosure, and the method of visual assistance implemented by means of this device, fulfil the task as well as the purposes set as they allow blind and visually impaired people to perceive in real time and with ease what surrounds them, and in particular to perceive in real time the presence of risks and their degree of risk.

Another advantage of the wearable device according to the disclosure is providing a comfortable and lightweight to wear device, just like a normal pair of glasses. In fact, the electronic components have weights and dimensions that make it absolutely integrable into a common pair of glasses.

Yet a further advantage of the wearable device according to the disclosure is that it can be designed and manufactured in such a way as to be aesthetically pleasing, elegant and attractive.

In addition, the wearable device for visual assistance is able to have a very wide overall viewing angle, in the order at least of 120°-160° and is able to identify with precision objects or obstacles that are even more than 4 metres away from the wearer.

Yet another advantage of the wearable device is that it is provided with a power supply battery and can operate in a “stand alone” configuration, without the aid of smartphones or other electronic devices.

Yet, the wearable device for visual assistance, according to the disclosure, makes use of electronic components and sensors having a low cost, and also very low electric consumption. Yet another advantage of the wearable device for visual assistance, according to the disclosure, is that it allows the wearer to perceive, through sounds, not only the presence of one or more moving objects in the scene, but also their position and their movement in the space, also providing a signal indicative of the risk of the object itself, as a function of the position and movement of the wearer.

Furthermore, the possibility of creating a mechanical or electromyographic stimulation of the skin, according to a two-dimensional map that reproduces in an approximate manner the scene that stands in front of the wearer of the wearable device, further contributes to immediately conveying useful information about the surrounding environment.

The wearable device for visual assistance, and the related method of visual assistance, also make it possible to compensate for the (possibly partial) inability of the user not to see, so the real-time application must be particularly accurate and precise; this is further promoted by the presence of a dedicated self-learning module and calibration of the behaviour of the device linked to the audio environment perceived by the acoustic sensor.

The wearable device for visual assistance, and the related method of visual assistance, therefore allow to satisfy the constraint of discretion and elegance, given the application in the specific field of visual assistance, contrary to the different gaming contexts, where these constraints are of no relevance.

The wearable device for visual assistance, and the related method of visual assistance, thus conceived are susceptible to numerous modifications and variants all falling within the scope of the inventive concept.

Furthermore, all the details can be replaced by other technically equivalent elements. In practice, any materials can be used according to requirements, as long as they are compatible with the specific use, the dimensions and the contingent shapes.

1. A wearable device for visual assistance, particularly for blind and/or visually impaired people, comprising:
at least one position and/or movement sensor configured to detect the position and/or movement of the wearable device in the space and to generate a signal indicative of the position and/or movement of the wearable device in the space;
a plurality of distance sensors each configured to detect the distance of one or more objects present in the space with respect to the distance sensor and to generate, each one, a signal indicative of the distance of said one or more objects from said distance sensor;
at least one pair of acoustic generators each configured to generate an acoustic signal, said acoustic generators being associated with said wearable device in two mutually distant positions;
a processing unit configured for, at each instant of time:
receiving as input said signal indicative of the position and/or movement of the wearable device and processing signals indicative of the position, velocity and acceleration of the wearable device;
receiving as input said signals indicative of the distance of said one or more objects generated by said distance sensors and processing signals indicative of the position, velocity and acceleration of said one or more objects with respect to said wearable device;
processing, on the basis of said signals indicative of the position, velocity and acceleration of the wearable device and of said signals indicative of the position, velocity and acceleration of said one or more objects with respect to said wearable device a warning signal associated with each of said one or more objects comprising:
the position, velocity and acceleration of said object with respect to said wearable device and
a risk index that identifies a risk attributed to said object;
actuating said pair of acoustic generators to generate a plurality of three-dimensional sounds, each associated with a respective object, wherein:
the tonality and/or pitch of each of said three-dimensional sounds is associated with said respective object;
the virtual point of origin of each of said three-dimensional sound is associated with the position of said respective object with respect to said wearable device;
the volume of each of said three-dimensional sound is associated with said risk index of said respective object.

2. The wearable device, according to claim 1, wherein the device is shaped like glasses, wherein said glasses comprise a front and a pair of temples, wherein said distance sensors are applied to said front and wherein the acoustic generators of said pair of acoustic generators are respectively applied to said temples of said pair of temples.

3. The wearable device according to claim 1, wherein said distance sensors are ultrasonic sensors.

4. The wearable device, according to claim 2, comprising three distance sensors applied to said front respectively at the two lateral ends and at the center of said front.

5. The wearable device, according to claim 1, wherein said acoustic generators are bone conduction transducers.

6. The wearable device according to claim 1, comprising at least one electromechanical or electromyographic actuator adapted to be placed in contact with the skin of the wearer and configured to generate a mechanical or electrical stimulation on the basis of said warning signal.

7. The wearable device, according to claim 1, comprising at least one acoustic sensor configured to detect environmental sounds and/or noises and to generate a corresponding environmental sound signal, said processing unit being configured to receive in input said environmental sound signal and to process a signal indicative of noises and/or sounds present in the surrounding environment, said processing unit processing said warning signal on the basis of said signal indicative of noises and/or sounds present in the surrounding environment.

8. A method of visual assistance, implemented with a wearable device for visual assistance, particularly for blind and/or visually impaired people, the method including the following steps:
a. detecting the position and/or movement of a wearable device in the space with at least one position and/or movement sensor and generating a signal indicative of the position and/or movement of the wearable device in the space;
b. detecting, with a plurality of distance sensors the distances of one or more objects present in the space with respect to the distance sensor and generating a signal indicative of the distance of said one or more objects from said distance sensor;
c. processing, on the basis of said signal indicative of the position and/or movement of the wearable device, signals indicative of the position, velocity and acceleration of said wearable device;
d. processing, on the basis of said signal indicative of the distance of said one or more objects generated by said distance sensors, signals indicative of the position, velocity and acceleration of said one or more objects with respect to said wearable device;
e. processing, on the basis of said signals indicative of the position, velocity and acceleration of said wearable device and of the position, velocity and acceleration of said one or more objects with respect to said wearable device a warning signal associated with each one of said one or more objects, said warning signal comprising:
i. the position, velocity and acceleration of said object with respect to said wearable device and
ii. a risk index that identifies a risk attributed to said object and
f. generating a plurality of three-dimensional sounds, with at least one pair of acoustic generators, wherein each three-dimensional sound is associated with a respective object, and wherein:
i. the tonality and/or pitch of each of said three-dimensional sounds is associated with said respective object;
ii. the virtual point of origin of each of said three-dimensional sound is associated with the position of said respective object with respect to said wearable device;
iii. the volume of each of said three-dimensional sound is associated with said risk index of said respective object.

9. The method according to claim 8, wherein said distance sensors are ultrasonic sensors adapted to generate a signal comprising a first signal indicative of the radial distance of an object and a second signal indicative of the amplitude of the ultrasound reflected by said object, wherein said step d. comprises the following sub-steps:
d1. comparing, for each distance sensor, the respective second signals indicative of the amplitude to establish whether said second signals are to be attributed to the same object;
d2. if said second signals are attributed to the same object, triangulating said first signals indicative of the radial distance of said same object to obtain said signals indicative of the position, velocity and acceleration of said same object with respect to said wearable device.

10. The method according to claim 9, wherein said step e. comprises the following sub-steps:
e1. comparing, for each object of said step d2, the second signals indicative of the amplitude, at the current instant of time and at the previous instant of time, to establish whether said second signals indicative of the amplitude are to be attributed to the same object;
e2. attributing said warning signal only to said objects identified in said step e1.

11. The method according to claim 8, wherein said risk index identifying the risk attributed to said object is established on the basis, at least, of the difference between the velocity and acceleration signals of said object with respect to said wearable device at the current instant of time and the velocity and acceleration signals of said object with respect to said wearable device at the previous instant of time.
